(19) United States
(12) Patent Application Publication
(10) Pub. No.: US 2012/0330695 A1
(43) Pub. Date: Dec. 27, 2012

(54) Apparatus, System and Method for Purchasing a Product

(75) Inventor: Richard Gallo, New York, NY (US)

(73) Assignee: Portable Fare Systems, LLC, New York, NY (US)

(21) Appl. No.: 13/534,396

(22) Filed: Jun. 27, 2012

Related U.S. Application Data
(60) Provisional application No. 61/501,548, filed on Jun. 27, 2011.

(51) Int. Cl. G06Q 20/40

(52) U.S. Cl. 705/5

(57) ABSTRACT

A system. The system includes a computing device which includes a processor and a ticket module communicably connected to the processor. The ticket module is configured to transmit information regarding a purchased product to a mobile computing device communicably connected to the system. The information includes at least one authentication feature which allows an electronic representation of the purchased product to be authenticated based solely on a visual inspection of the electronic representation. The information also includes control data for controlling the generation of the electronic representation of the purchased product.

### CROSS-REFERENCE TO RELATED APPLICATION

This application claims the benefit under 35 U.S.C. §119(e) of the earlier filing date of U.S. Provisional Patent Application No. 61/501,548 filed on Jun. 27, 2011, the content of which is hereby incorporated by reference.

### BACKGROUND

This application discloses an invention which is related, generally and in various embodiments, to an apparatus, system and method for purchasing a product (i.e., a good or a service).

Each year, more and more goods and/or services are being purchased online. In general, a consumer uses a computing device to access a given web site, selects one or more goods and/or services to be purchased, provides financial information regarding how the goods and/or services are to be paid for (e.g., MasterCard, account number, expiration date, security code), and provides delivery information regarding the desired destination for the purchased goods and/or services. Once the purchase amount and any relevant fees are charged to the consumer's financial account, the purchased goods and/or services are shipped to the desired destination.

Increasingly, more and more of such purchases are being executed with mobile computing devices (e.g., smart phones, personal digital assistants, tablets, internet-enabled devices). For example, consumers are utilizing mobile computing devices to purchase tickets for airline flights, tickets to sporting events, tickets to concerts and movie tickets. Although such tickets were historically required to be picked up at the applicable venue or printed out on a “hard copy” for subsequent authentication/verification with a dedicated hardware device (e.g., a barcode scanner) at the applicable venue, some of such tickets can now be represented on the displays of the mobile computing devices. However, such tickets still need to be authenticated/verified with a dedicated hardware device and an active link to a server.

### BRIEF DESCRIPTION OF THE DRAWINGS

Various embodiments of the invention are described herein in by way of example in conjunction with the following figures, wherein like reference characters designate the same or similar elements.

FIG. 1 illustrates various embodiments of a system;

FIG. 2 illustrates various embodiments of a computing system of the system of FIG. 1;

FIG. 3 illustrates various embodiments of a mobile computing device of the system of FIG. 1;

FIGS. 4-6 are exemplary screen shots of the mobile computing device shown in FIG. 1; and

FIG. 7 illustrates various embodiments of a method.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

As described in more detail hereinbelow, aspects of the invention may be implemented by a computing device and/or a computer program stored on a computer-readable medium. The computer-readable medium may comprise a disk, a device, and/or a propagated signal.

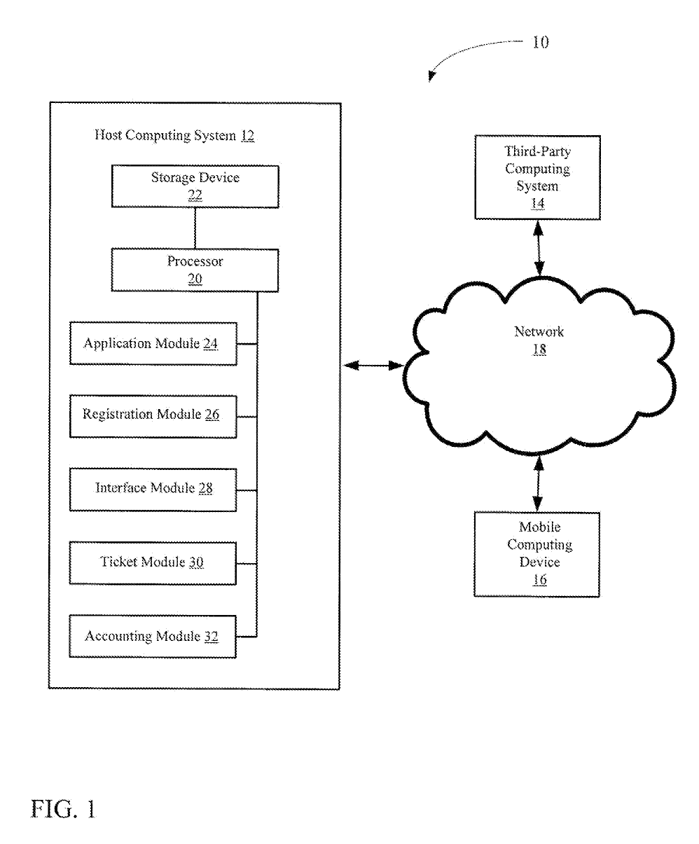

FIG. 1 illustrates various embodiments of a system 10. The system 10 may be utilized to execute a purchase of a product. As used herein, the term “product” refers to one or more goods and/or services. The system 10 includes a host computing system 12 communicably connected to a third-party computing system 14 and a mobile computing device 16 via one or more networks 18. Although only one third-party computing system 14 and one mobile computing device 16 is shown in FIG. 1, it will be appreciated that the host computing system 12 may be communicably connected to any number of different third-party computing systems 14 and any number of different mobile computing devices 16. Various embodiments of the system 10 may be utilized to execute a purchase of any number of different products. However, for purposes of simplicity, the system 10 will be described in the context of a system utilized to execute a purchase of a private transit ticket (i.e., a ticket for utilizing transportation provided by a taxicab, a limousine, a bus; a shuttle bus, a taxibus, a motor coach, a rail vehicle, a light rail vehicle, a ferry, a helicopter, etc.).

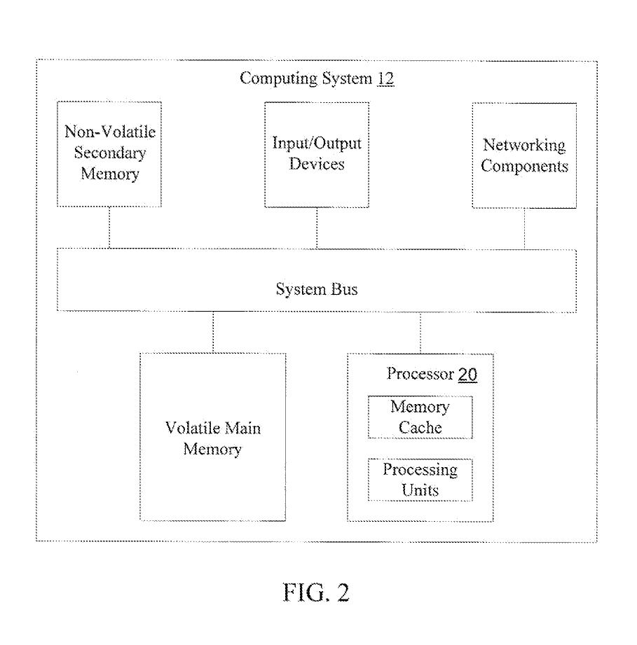

The host computing system 12 may include any suitable type of computing device that includes at least one processor 20. For example, according to various embodiments, the host computing system 12 may include one or more servers, desktops, laptops, etc. which can be communicably connected to the network 18. Various embodiments of the host computing system 12 are described in more detail hereinbelow with respect to FIG. 2.

The third-party computing system 14 may include any suitable type of computing device. For example, according to various embodiments, the third-party computing system 14 may include one or more servers, desktops, laptops, etc. which can be communicably connected to the network 18. The third-party computing system 14 may be associated with any provider of goods and/or services. For example, according to various embodiments, the third-party computing system 14 is associated with a private transportation company (e.g., a private bus company, a private motor coach company, etc.) and is configured to provide information regarding the routes, schedules, costs, etc. for the services offered by the company.

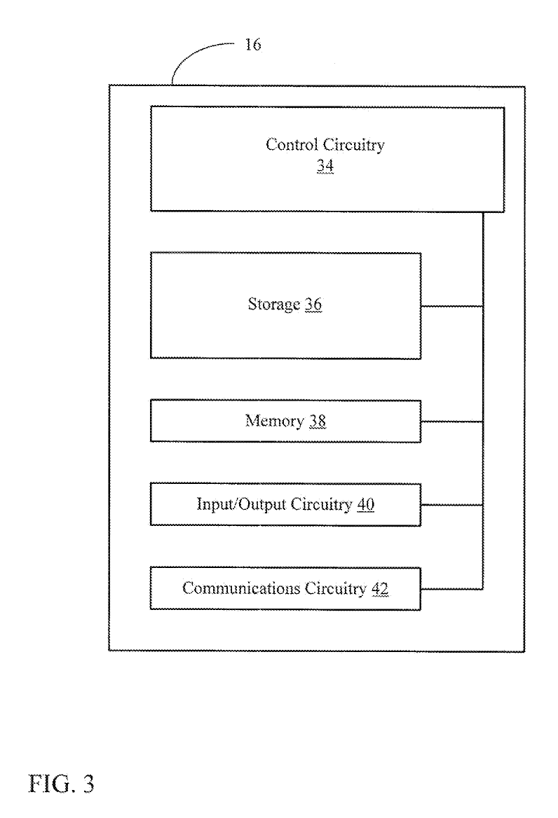

The mobile computing device 16 may be any suitable type of mobile computing device. For example, according to various embodiments, the mobile computing device 12 may be embodied as a tablet, a smart phone, a personal digital assistant, etc. which can be communicably connected to the network 18. As described in more detail hereinbelow, the mobile computing device 16 may be utilized to purchase a good or service (e.g., a private transit ticket) via the host computer system 12, and to generate and display an electronic representation of the purchased ticket. According to various embodiments, under certain circumstances, the mobile computing device 16 may generate and display the electronic representation of the purchased ticket even if the mobile computing device 16 and the host computing system 12 are no longer communicably connected to one another. Various embodiments of the mobile computing device 16 are described in more detail hereinbelow with respect to FIG. 3.

Each of the one or more networks 18 may include any type of delivery system including, but not limited to, a local area network (e.g., Ethernet), a wide area network (e.g. the Internet and/or World Wide Web), a telephone network (e.g., analog, digital, wired, wireless, fiber optic, PSTN, ISDN, GSM, GPRS, and/or xDSL), a packet-switched network, a radio network, a television network, a cable network, a satellite network, and/or any other wired or wireless communications network configured to carry data. A given network 18 may include elements, such as, for example, intermediate nodes, proxy servers, routers, switches, and adapters configured to direct and/or deliver data. In general, the host computing system 12 may be structured and arranged to communicate with the third-party computing system 14 and the mobile computing device 16 via the one or more networks 18 using various communication protocols (e.g., HTTP, HTTPS, NFC, TCP/IP, UDP, WAP, WiFi, Bluetooth) and/or to operate within or in concert with one or more other communications systems.

As shown in FIG. 1, according to various embodiments, the host computing system 12 includes a storage device 22, an application module 24, a registration module 26, an interface module 28, a ticket module 30 and an accounting module 32.

The storage device 22 is communicably connected to the processor 20. As shown in FIG. 1, the storage device 22 may be integral with the host computing system 12. According to other embodiments, the storage device 22 is remote from but communicably connected to the host computing system 12. Information provided to the host computing system 12 by the third-party computing systems 14 and the mobile computing devices 16 may be organized into one or more databases residing at the storage device 22. Although only one storage device 22 is shown in FIG. 1, it will be appreciated that the host computing system 12 may include any number of storage devices 22.

The application module 24 is communicably connected to the processor 20 and includes an application (e.g., a software module). According to various embodiments, a copy of the application can be uploaded to an application store (e.g., Apple iTunes App Store, Google Apps Marketplace, etc.) for subsequent download to the mobile computing device 16. According to other embodiments, the application may be downloaded from the host computing system 12 to the mobile computing device 16 via the network 18. The downloaded application allows the mobile computing device 16 to be subsequently utilized to purchase a product (e.g., a private transit ticket) via the host computing system 12, and to generate an electronic representation of the private transit ticket which can be displayed by the mobile computing device 16 and visually authenticated by a person without the need for any type of hardware device. Under certain circumstances, the downloaded application allows the mobile computing device 16 to generate and display the electronic representation of the private transit ticket even if the mobile computing device 16 and the host computing system 12 are no longer communicably connected to one another. According to various embodiments, the full functionality of the application does not become available until after the mobile computing device 16 is registered with the host computing system 12. For example, according to various embodiments, the application may be utilized by the mobile computing device 16 to view a private transit schedule (e.g., a schedule for a private bus company, a private motor coach company, etc.) via the host computing system 12 prior to such registration, but may not be able to be utilized to complete the purchase of the private transit ticket until after such registration has been completed.

The registration module 26 is communicably connected to the processor 20, and is configured to register one or more mobile computing devices 16 with the host computing system 12. As part of the registration process, information regarding the mobile computing device 16 and a person associated with the mobile computing device 16 is provided to the host computing system 12, and such information may be stored in a database residing at the storage device 22. Such information may include, for example, information about the mobile computing device 16 (e.g., a unique device identifier associated with the mobile computing device 16), information regarding the form of payment to be utilized for subsequent purchases (e.g., brand of credit card, account number, expiration date, etc.), and information about the person (e.g., the person's name, address, date of birth, gender, height, weight, hair color, eye color, cell phone telephone number, etc.). According to various embodiments, some of such information (e.g., a unique device identifier associated with the mobile computing device 16) may be automatically captured by the host computing system 12.

According to various embodiments, the registration module 26 may also be configured to integrate one or more private transit operators associated with the third-party computing systems 14 with the host computer system 12. As part of the integration process, information regarding the private transit operators is provided to the host computing system 12, and such information may be stored in a database residing at the storage device 22. Such information may include, for example, information about the private transit operator (e.g., company name and address, contact information for company representative, company's terms and conditions, a format to be used for an electronic ticket, etc.) and information regarding the third-party computing system 14 associated with the private transit operator (e.g., Internet address, approved communication protocols, etc.). According to various embodiments, such information may be manually entered to the host computing system 12 even if the private transportation company does not have a computing system or have such information on its computing system.

The interface module 28 is communicably connected to the processor 20, and is configured to provide one or more mobile computing devices 16 with a common interface to the third-party computing systems 14 communicably connected to the host computing system 12. As described in more detail hereinbelow, for each mobile computing device 16 having an application communicably connected to the host computing system 12, the interface module 26 provides a common interface for the one or more mobile computing devices 16 to gain access to information (e.g., private transit schedules) residing at any number of the third party computing systems 14 via the host computing system 12. According to various embodiments, the interface module 26 may be utilized by the mobile computing device 16 to purchase a given private transit ticket by selecting/clicking a given screen icon (a “purchase” icon).

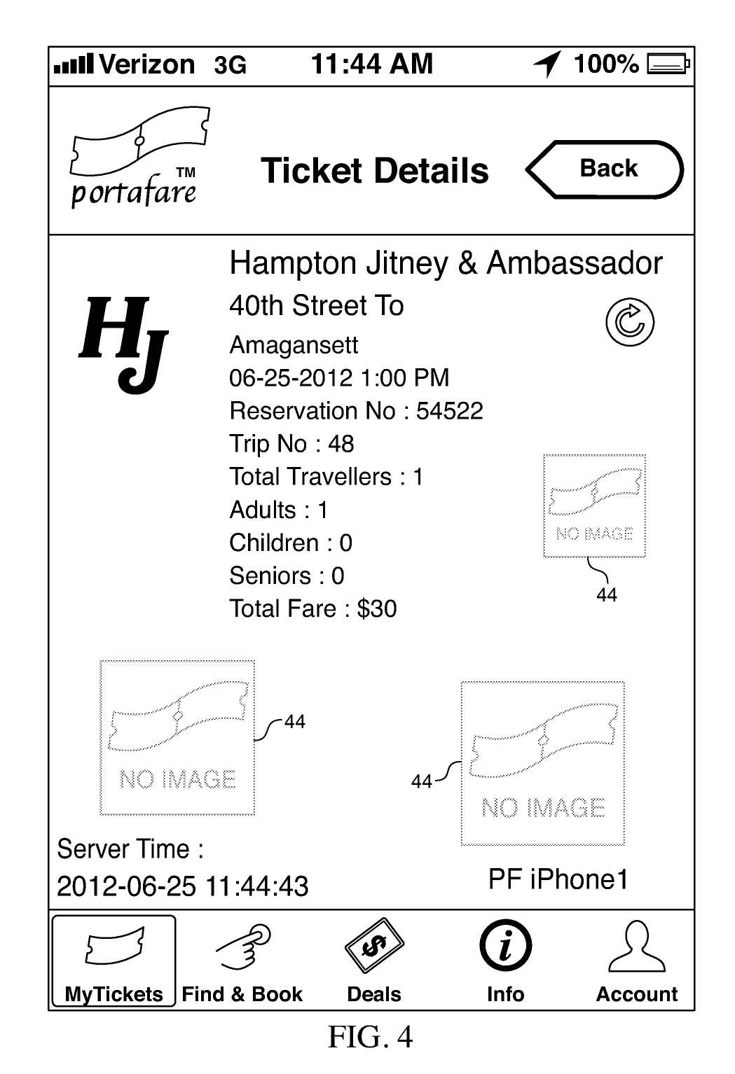

The ticket module 30 is communicably connected to the processor 20, and is configured to provide information regarding the purchased private transit ticket to the mobile computing device 16. The information may be encrypted prior to being provided to the mobile computing device 16. As described in more detail hereinafter, such information is utilized by the mobile computing device 16 to complete the generation and display of the electronic representation of the purchased ticket, and may include, for example, information regarding the trip (e.g., a date, a time, a boarding location, a destination, etc.), one or more ticket authentication features, and control data for controlling the generation and display of the electronic representation of the purchased ticket by the mobile computing device 12. Exemplary screen shots of such electronic representations displayed by the mobile computing device 16 are shown in FIGS. 4-6 and described in more detail hereinbelow. According to various embodiments, the control data may be embodied as a set of rules which control when an authentication feature (or the entire ticket) can start being displayed by the mobile computing device 16, a period of time that the ticket authentication feature can still be displayed after the host computing system 12 and the mobile computing device 16 are no longer communicably connected to one another, how often a given ticket authentication feature should be changed, one or more locations where the mobile computing device 16 can generate and display the electronic representation of the purchased ticket, etc. According to various embodiments, the mobile computing device 16 may be able to generate and display an electronic representation of the ticket (without the one or more authentication features) shortly after the ticket is purchased, regardless of when the ticket will be used.

According to various embodiments, the ticket authentication feature is a dynamic authentication feature which can be highly configurable. For example, according to various embodiments, when the electronic representation of the purchased ticket is displayed by the mobile computing device 16, the authentication feature may be in the form of a set of images, where the images are periodically rotated so that only one of the images is displayed at a given time. According to other embodiments, the images can be rotated based on the day and/or time, based on a geographic location of the mobile computing device 16, based on movement from one geographic location to another geographic location, etc. According to various embodiments, the authentication feature may be in the form of a particular image, where the image is only displayed if the display of the mobile computing device 16 is touched in a certain location, if a certain pattern (e.g., a “Z” pattern) is traced on the display of the mobile computing device 16, etc. According to other embodiments, the authentication feature may be in the form of something other than an image (e.g., a serial number, a barcode, a quick response (QR) code, one or more letters, numbers, symbols, etc.). According to various embodiments, the authentication feature may be an animation that can move across and/or around the display of the mobile computing device 16.

According to various embodiments, the control data may operate to prevent the mobile computing device 16 from being able to display the electronic representation of the ticket until some predetermined time before the scheduled boarding time. According to various embodiments, the control data may operate to allow the mobile computing device 16 to display the electronic representation of the ticket only if the mobile computing device 16 is at or proximate to certain geo-locations. According to various embodiments, the control data may operate to limit how long after a data link (e.g., an Internet connection) between the mobile computing device 16 and the host computing device 12 becomes inactive that the mobile computing device 16 may still display the electronic representation of the purchased ticket.

The duration of inactivity of the data link may be determined in any suitable manner. For example, according to various embodiments, the host computer system 12 logs the processor time of the mobile computing device 16 each time the host computer system 12 is pinged by the mobile computing device 16. By comparing the logged time with a clock time associated with the host computer system 12, the host computing system 12 can determine approximately how long the data link has been inactive. If the determined duration is within a configurable time set forth in the control data, the mobile computing device 16 can still display the electronic representation of the purchased ticket. However, if the determined duration is not within the configurable time set forth in the control data, the mobile computing device 16 can be blocked from displaying the electronic representation of the purchased ticket. According to other embodiments, the duration of inactivity of the data link may be determined at the mobile computing device 16.

The accounting module 32 is communicably connected to the processor 20, and is configured to process payment for the purchased ticket. Such processing may include, for example, debiting a first amount from an account associated with the mobile computing device 16, crediting the first amount to an account associated with the host computing system 12, debiting a second amount from the account associated with the host computing system 12, and crediting an account associated with the private transit operator. According to other embodiments, such processing may include, for example, debiting a first amount from an account associated with the mobile computing device 16, crediting the first amount to an account associated with the private transit operator, debiting a second amount from the account associated with the private transit operator, and crediting an account associated with the host computing system 12.

The modules 24-32 may be communicably connected with one another, and may be implemented in hardware, firmware, software and combinations thereof. For embodiments utilizing software, the software may utilize any suitable computer language (e.g., C, C++, C#, Perl, Java, JavaScript, Visual Basic, VBScript, Delphi) and may be embodied permanently or temporarily in any type of machine, component, physical or virtual equipment, storage medium, or propagated signal capable of delivering instructions to a device. The modules 24-32 (e.g., software application, computer program) may be stored on a computer-readable medium (e.g., disk, device, and/or propagated signal) such that when a computer reads the medium, the functions described herein-above are performed. According to various embodiments, the above-described functionality of the modules 24-32 may be combined into fewer modules, distributed amongst additional modules, etc.

FIG. 2 illustrates various embodiments of the host computing system 12. The host computing system 12 may be embodied as one or more computing devices, and includes networking components such as Ethernet adapters, non-volatile secondary memory such as magnetic disks, input/output devices such as keyboards and visual displays, volatile main memory, and a processor 20. Each of these components may be communicably connected via a common system bus. The processor 20 includes processing units and on-chip storage devices such as memory caches.

According to various embodiments, the host computing system 12 includes one or more modules which are implemented in software, and the software is stored in non-volatile memory devices while not in use. When the software is needed, the software is loaded into volatile main memory. After the software is loaded into volatile main memory, the processor 20 reads software instructions from volatile main memory and performs useful operations by executing sequences of the software instructions on data which is read into the processor 20 from volatile main memory. Upon completion of the useful operations, the processor 20 writes certain data results to volatile main memory.

FIG. 3 illustrates various embodiments of the mobile computing device 16. Mobile computing device 16 can include control circuitry 34, storage 36, memory 38, input/output (“I/O”) circuitry 40, and communications circuitry 42. According to some embodiments, one or more of the components of the mobile computing device 16 can be combined or omitted (e.g., storage 36 and memory 38 may be combined). According to some embodiments, the mobile computing device 16 can include other components not combined or included in those shown in FIG. 3 (e.g., motion detection components, a power supply such as a battery or kinetics, a display, bus, a positioning system, a camera, an input mechanism, an accelerometer, a global positioning system chip, etc.), or several instances of the components shown in FIG. 3. For purposes of simplicity, only one of each of the components is shown in FIG. 3.

The control circuitry 34 includes a processor (or processing circuitry) operative to control the operations and performance of the mobile computing device 16. For example, the control circuitry 34 can be used to run operating system applications, firmware applications, media playback applications, media editing applications, or any other application. According to various embodiments, the control circuitry 34 can drive a display and process inputs received from a user interface.

The storage 36 can include, for example, one or more storage mediums including a hard-drive, solid state drive, flash memory, permanent memory such as ROM, any other suitable type of storage component, or any combination thereof. The storage 36 can store a copy of the application software downloaded from the host computing system 12, as well as the information associated with the purchased private transit ticket, including the one or more ticket authentication features. The storage 36 can also store, for example, media data (e.g., music and video files), application data (e.g., for implementing functions on the mobile computing device 16), firmware, user preference information data (e.g., media playback preferences), authentication information (e.g. libraries of data associated with authorized users), lifestyle information data (e.g., food preferences), exercise information data (e.g., information obtained by exercise monitoring equipment), transaction information data (e.g., information such as credit card information), wireless connection information data (e.g., information that can enable the mobile computing device 16 to establish a wireless connection), subscription information data (e.g., information that keeps track of podcasts or television shows or other media a user subscribes to), contact information data (e.g., telephone numbers and email addresses), calendar information data, and any other suitable data or any combination thereof.

The memory 38 can include cache memory, semi-permanent memory such as RAM, and/or one or more different types of memory used for temporarily storing data. According to various embodiments, the memory 38 can also be used for storing data used to operate electronic device applications, or any other type of data that can be stored in the storage 36. According to some embodiments, the memory 38 and the storage 36 can be combined as a single storage medium.

The I/O circuitry 40 can be operative to convert (and encode/decode, if necessary) analog signals and other signals into digital data. According to various embodiments, the I/O circuitry 40 can also convert digital data into any other type of signal, and vice-versa. For example, the I/O circuitry 40 can receive and convert physical contact inputs (e.g., from a multi-touch screen), physical movements (e.g., from a mouse or sensor), analog audio signals (e.g., from a microphone), or any other input. The digital data can be provided to and received from the control circuitry 34, the storage 36, the memory 38, or any other component of the mobile computing device 16. Although the I/O circuitry 40 is illustrated in FIG. 3 as a single component of the mobile computing device 16, several instances of I/O circuitry 40 can be included in the mobile computing device 16.

The mobile computing device 16 can include any suitable interface or component for allowing a user to provide inputs to the I/O circuitry 40. For example, the mobile computing device 16 can include any suitable input mechanism, such as for example, a button, keypad, dial, a click wheel, or a touch screen. According to some embodiments, the mobile computing device 16 can include a capacitive sensing mechanism, or a multi-touch capacitive sensing mechanism.

According to various embodiments, the mobile computing device 16 can include specialized output circuitry associated with output devices such as, for example, one or more audio outputs. The audio output can include one or more speakers (e.g., mono or stereo speakers) built into the mobile computing device 16, or an audio component that is remotely coupled to the mobile computing device 16 (e.g., a headset, headphones or earbuds that can be coupled to communications device with a wire or wirelessly).

In some embodiments, the I/O circuitry 40 can include display circuitry (e.g., a screen or projection system) for providing a display visible to the user (or to a person associated with the private transit company). For example, the display circuitry can include a screen (e.g., an LCD screen) that is incorporated in the mobile computing device 16. As another example, the display circuitry can include a movable display or a projecting system for providing a display of content on a surface remote from the mobile computing device 16 (e.g., a video projector). In some embodiments, the display circuitry can include a coder/decoder (Codec) to convert digital media data into analog signals. For example, the display circuitry (or other appropriate circuitry within the mobile computing device 16) can include video Codecs, audio Codecs, or any other suitable type of Codec.

The display circuitry also can include display driver circuitry, circuitry for driving display drivers, or both. The display circuitry can be operative to display content (e.g., media playback information, application screens for applications implemented on the mobile computing device 16, information regarding ongoing communications operations, information regarding incoming communications requests, or device operation screens) under the direction of the control circuitry 34. Alternatively, the display circuitry can be operative to provide instructions to a remote display.

The communications circuitry 42 can include any suitable communications circuitry operative to connect to the network 18 and to transmit communications (e.g., voice or data) from the mobile computing system 16 to other systems or devices communicably connected to the network 18. The communications circuitry 42 can be operative to interface with the network 18 using any suitable communications protocol such as, for example, Wi-Fi (e.g., a 802.11 protocol), Bluetooth™, radio frequency systems (e.g., 900 MHz, 1.4 GHz, and 5.6 GHz communication systems), infrared, GSM, GSM plus EDGE, CDMA, quadband, and other cellular protocols, VOIP, or any other suitable protocol.

According to various embodiments, the communications circuitry 42 can be operative to create a communications network using any suitable communications protocol. For example, the communications circuitry 42 can create a short-range communications network using a short-range communications protocol to connect to other devices. For example, the communications circuitry 42 can be operative to create a local communications network using the Bluetooth™ protocol to couple the mobile computing device 16 with a Bluetooth™ headset.

The mobile computing device 16 can include one more instances of the communications circuitry 42 for simultaneously performing several communications operations using different communications networks, although only one is shown in FIG. 3 to avoid overcomplicating the drawing. For example, the mobile computing device 16 can include a first instance of the communications circuitry 42 for communicating over a cellular network, and a second instance of the communications circuitry 42 for communicating over Wi-Fi or using Bluetooth™. According to various embodiments, the same instance of the communications circuitry 42 can be operative to provide for communications over several communications networks.

According to various embodiments, the mobile computing device 16 can be coupled to a host device (e.g., host computing system 12) for data transfers, synching the mobile computing device 16, software or firmware updates, providing performance information to a remote source (e.g., providing riding characteristics to a remote server) or performing any other suitable operation that can require the mobile computing device 16 to be coupled to a host device. Several mobile computing devices 16 can be coupled to a single host device using the host device as a server. Alternatively or additionally, mobile communication device 16 can be coupled to several host devices (e.g., for each of the plurality of the host devices to serve as a backup for data stored in the mobile computing device 16).

Once the application software is downloaded to the mobile computing device 16 (e.g., from an App Store) and the mobile computing device 16 is registered with the host computing system 12, the mobile computing device 16 is configured to purchase any number of different private transit tickets via the host computing system 12 from any number of different private transit providers, and to subsequently generate electronic representations of the purchased private transit tickets which can be displayed by the mobile computing device 16 and visually authenticated by a person without the need for any other type of hardware device.

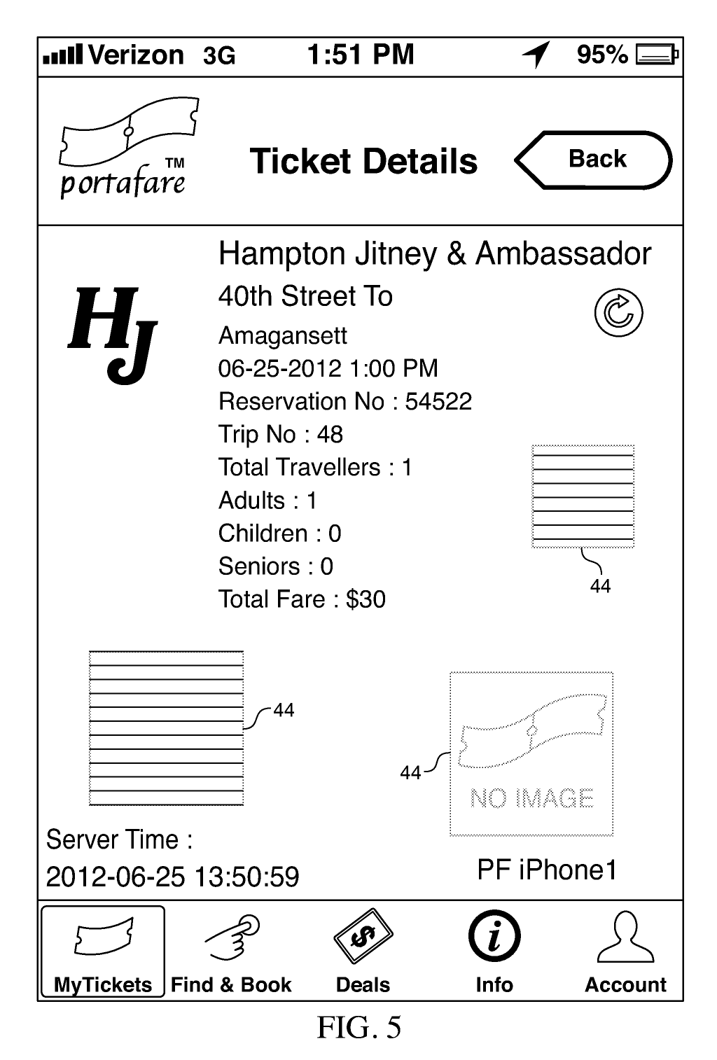

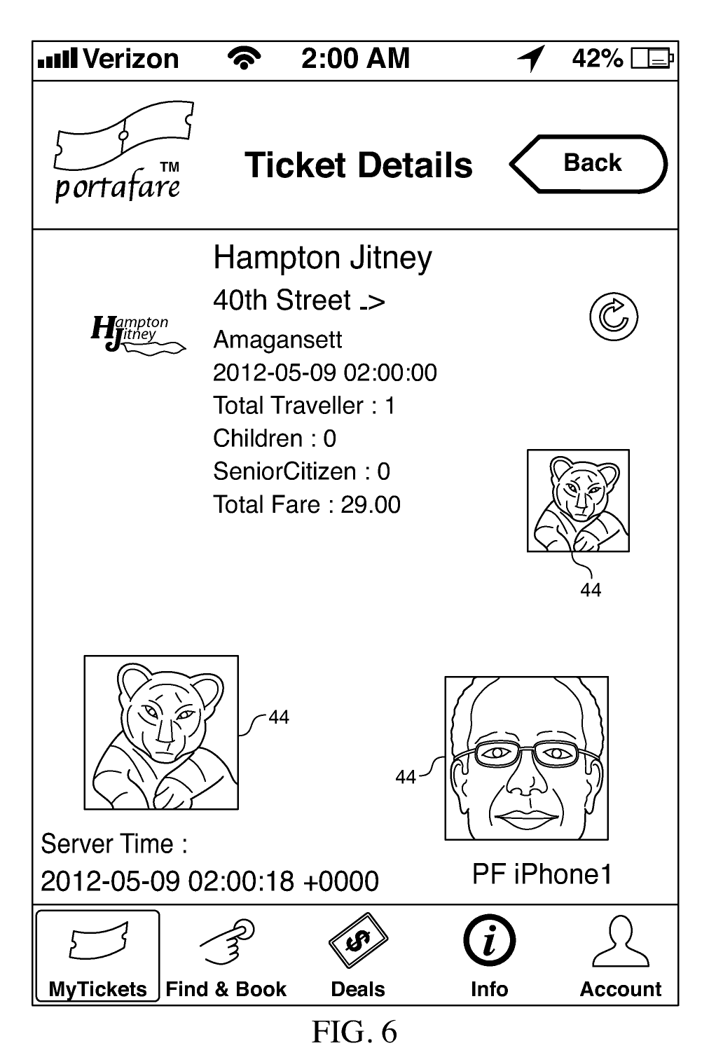

FIGS. 4-6 are exemplary screen shots of the mobile computing device 16. FIG. 4 illustrates various embodiments of an electronic representation of a surface transportation ticket, where the trip information is set forth in text but no authentication features are displayed in the areas 44 formatted to display the authentication features. In the electronic representation shown in FIG. 4, there are three of these areas 44 and the areas are labeled “no image” to signify that the areas 44 are void of any authentication features. FIG. 5 illustrates other embodiments of an electronic representation of a surface transportation ticket. The electronic representation is similar to that of FIG. 4, but is different in that two of the three areas 44 for displaying authentication features are now “filled” (the third area 44 is labeled “no image” to signify that it is void of an authentication feature). In this instance, the two areas 44 are filled with a color which is different than the background of the display screen of the mobile computing device 16. The color may be any suitable color, and according to various embodiments, these colors may change based on time, geo-location, etc. Also, according to various embodiments, the different areas 44 may be filled with different colors, images, etc. FIG. 6 illustrates yet other embodiments of an electronic representation of a surface transportation ticket. The electronic representation is similar to that of FIG. 5, but is different in that the three areas 44 are filled with images. In this instance, two of the areas 44 are filled with identical images of a tiger and the third area 44 is filled with an image of a person (e.g., a person associated with the mobile computing device 16). The images may be any suitable images, and according to various embodiments, these images may change based on time, geo-location, etc. Also, according to various embodiments, the different areas 44 may be filled with different images, colors, etc. It will be appreciated that the mobile computing device 16 may generate and display any number of different electronic representations, with many different arrangements and combinations of authentication features.

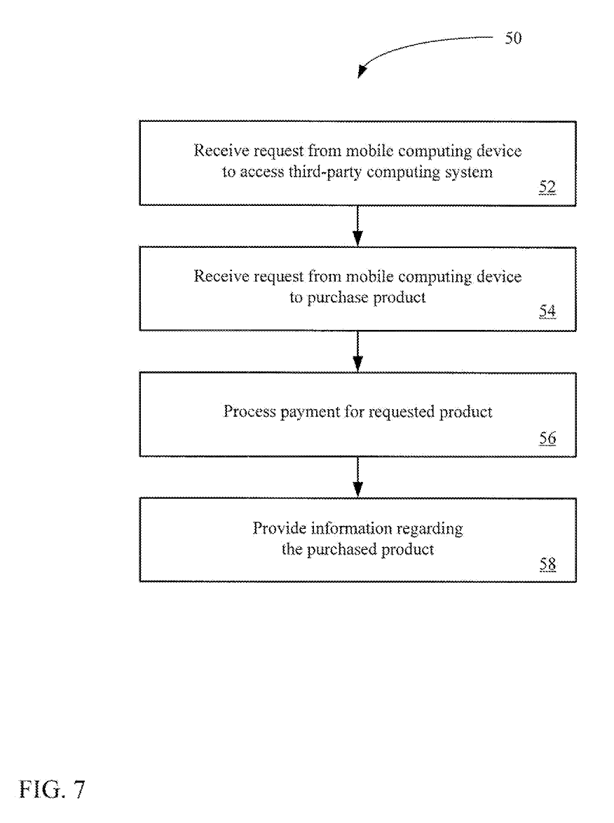

FIG. 7 illustrates various embodiments of a method 50 for purchasing a product (e.g., a good and/or a service). Although the product may be any suitable type of product and may be purchased from any provider, the method 50 will be described in the context of the purchase of a ticket from a private bus company for purposes of simplicity. According to various embodiments, the method 50 may be implemented by the system 10. For purposes of simplicity, the method 50 will be described in the context of being implemented by the system 10. However, it will be appreciated that the method 50 may be implemented by systems/devices other than the system 10.

Prior to the start of the process, the computing systems of various private transit operators (e.g., private bus companies, private motor coach companies, etc.) are integrated with the host computing system 12. As described hereinabove, as part of the integration process, information regarding the transit operators and their third-party computing systems 16 are provided to the host computing system 12. After the integration is completed, the transit schedules and other information residing at the third-party computing systems 14 can be accessed via the host computing system 12. For instances where the private transit operator does not have a computing system or information regarding transit schedules on their computing systems, such information can be manually entered to the host computing system 12. Also prior to the start of the process, application software is downloaded to the mobile computing device 16, and the mobile computing device 16 is registered with the host computer system 12.

The process starts at block 52, where the host computing system 12 receives a request from the mobile computing device 16 to access information associated with the bus company. The information may reside at either the host computing system 12 or at the third-party computing system 14 associated with the bus company. Such information may include, for example, bus numbers, bus schedules, bus stops, ticket prices, etc. Responsive to the request, the host computing system 12 accesses the information (either from the storage device 22 or from the third-party computing system 14) and forwards a “copy” of the information to the mobile computing device 16. The mobile computing device 16 receives a “copy” of the information from the host computing system 12 and displays the information on a display device of the mobile computing device 16.

From block 52, the process advances to block 54, where the host computing system 12 receives a request from the mobile computing device to purchase the bus ticket (i.e., the product) from the host computing system 12. The mobile computing device 16 may generate the request in any suitable manner. For example, according to various embodiments, the mobile computing device 16 is utilized to select details associated with a desired trip (bus number, boarding date and time, destination, cost, etc.) and then select/click an icon (e.g., a purchase icon) displayed on the display device of the mobile computing device 16 to generate the ticket purchase request.

From block 54, the process advances to block 56, where the accounting module 32 process payment for the requested ticket purchase. If the accounting module 32 determines the funding source associated with the mobile computing device 16 (e.g., a credit card identified during the registration process, a debit card, a stored value account, etc.) has sufficient funds available for the requested purchase, the payment is processed. However, if the funds are not sufficient, the purchase request may be denied by the host computing system 12 and the process ends. According to various embodiments, prior to terminating the process, the funding source may be increased to ensure that sufficient funds are available. As explained hereinabove, the processing of the payment may include debiting an account associated with the mobile computing device 16 and crediting an account associated with the bus company.

From block 56, the process advances to block 58, where the ticket module 30 provides information regarding the purchased bus ticket to the mobile computing device 16. In general, as described hereinabove, the provided information includes trip information (e.g., a date, a time, a boarding location, a destination, etc.), one or more ticket authentication features (e.g., security images), and control data for controlling the generation and display of the electronic representation of the purchased ticket. According to various embodiments, the displayed electronic representation of the purchased ticket can be visually authenticated by a person (e.g., a person associated with the private bus company) without the need for any type of hardware device.

For such embodiments, the displayed electronic representation of the purchased ticket may be viewed and authenticated by an employee/representative/agent of the bus company (without the need for a hardware device such as a bar code scanner). In brief, the employee/representative/agent can view the displayed electronic ticket and the authentication feature to determine whether or not the electronic ticket is valid for the given bus on the given day at the given time. If the employee/representative/agent determines that the electronic ticket displayed on the mobile computing device 16 is valid, the consumer is granted access (or granted continued access) to the bus. If the employee/representative/agent determines that the electronic ticket displayed on the mobile computing device 16 is not valid (e.g., the displayed authentication feature is expired, the displayed authentication feature is not applicable until a later day/time, the displayed authentication feature is not one associated with the bus company, etc.), the consumer can be denied access to the bus (or have his access to the bus ended). For embodiments where the displayed electronic representation of the purchased ticket includes a barcode, a QR code, etc., the displayed electronic representation of the purchased ticket can also be authenticated by a hardware device.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the claimed invention. For example, although certain embodiments were described in the context of purchasing bus tickets, it will be appreciated that additional embodiments for purchasing other goods and/or services are within the scope of the claimed invention. It will also be appreciated that the described invention can be utilized to authenticate season passes, to authenticate the identification and/or credentials of employees, etc. Additionally, it will be appreciated that the described invention can utilize audible authentication (e.g., one or more tones) in lieu of or in addition to the visual authentication described hereinabove. Accordingly, it is understood that the drawings and the descriptions herein are proffered only to facilitate comprehension of the invention and should not be construed to limit the scope thereof.

What is claimed is:

1. A system, comprising:
a computing device, wherein the computing device comprises:
a processor; and
a ticket module communicably connected to the processor, wherein the ticket module is configured to transmit information regarding a purchased product to a mobile computing device communicably connected to the system, wherein the information comprises:
at least one authentication feature which allows an electronic representation of the purchased product to be authenticated based solely on a visual inspection of the electronic representation; and
control data for controlling the generation of the electronic representation of the purchased product.

2. The system of claim 1, wherein the information provided to the mobile computing device is encrypted.

3. The system of claim 1, wherein the purchased product is a transportation ticket.

4. The system of claim 1, wherein the purchased product is a private transportation ticket.

5. The system of claim 1, wherein the purchased product is at least one of the following:
a taxicab ticket;
a limousine ticket;
a bus ticket;
a shuttle bus ticket;
a taxibus ticket;
a motor coach ticket;
a rail ticket;
a light rail ticket;
a ferry ticket; and
a helicopter ticket.

6. The system of claim 1, wherein the at least one authentication feature comprises a dynamic authentication feature.

7. The system of claim 1, wherein the at least one authentication feature comprises a configurable authentication feature.

8. The system of claim 1, wherein the at least one authentication feature comprises an animation.

9. The system of claim 1, wherein the at least one authentication feature comprises at least one of the following:
an image;
a number;
a letter;
a symbol;
a barcode; and
a quick response code.

10. The system of claim 1, wherein the control data is operative to control when the mobile computing device can generate the electronic representation of the purchased product.

11. The system of claim 1, wherein the control data is operative to control where the mobile computing device can generate the electronic representation of the purchased product.

12. The system of claim 1, wherein the control data is operative to control how long after the system and the mobile computing device are no longer communicably connected the mobile computing device can still generate the electronic representation of the purchased product.

13. The system of claim 1, further comprising:
an interface module communicably connected to the processor, wherein the interface module is configured to provide the mobile computing device with a common interface to a plurality of third-party computing systems communicably connected to the computing device.

14. A method, implemented at least in part by a computing device, the method comprising:
at the computing device,
receiving a request from a mobile computing device communicably connected to the computing device to access information associated with a product;
transmitting the requested information to the mobile computing device;
receiving a request from the mobile computing device to purchase the product;
processing the purchase request; and
transmitting information associated with the product purchase to the mobile computing device, wherein the information associated with the product purchase comprises:
at least one authentication feature which allows an electronic representation of the purchased product to be authenticated based solely on a visual inspection of the electronic representation; and
control data for controlling the generation of the electronic representation of the purchased product.

15. The method of claim 14, wherein receiving the request to access information associated with the product comprises receiving a request to access information associated with a transportation company.

16. The method of claim 14, wherein receiving the request to access information associated with the product comprises receiving a request to access information associated with a private transportation company.

17. The method of claim 14, wherein transmitting the information associated with the purchased product comprises transmitting encrypted information associated with the purchased product.

18. The method of claim 14, wherein transmitting the at least one authentication feature comprises transmitting at least one of the following:
a dynamic authentication feature;
a configurable authentication feature;
an animation;
an image; and
a non-image.

19. The method of claim 14, wherein transmitting the control data comprises transmitting control data which is operative to control when the mobile computing device can generate the electronic representation of the purchased product.

20. The method of claim 14, wherein transmitting the control data comprises transmitting control data which is operative to control where the mobile computing device can generate the electronic representation of the purchased product.

21. The method of claim 14, wherein transmitting the control data comprises transmitting control data which is operative to control how long after the system and the mobile computing device are no longer communicably connected the mobile computing device can still generate the electronic representation of the purchased product.
